(19) United States
(12) Patent Application Publication
(10) Pub. No.: US 2014/0256305 A1
(43) Pub. Date: Sep. 11, 2014

(54) METHODS AND SYSTEMS FOR MODE SCHEDULING IN MOBILE DEVICES

(71) Applicant: Roman Ginis, Stamford, CT (US)

(72) Inventor: Roman Ginis, Stamford, CT (US)

(21) Appl. No.: 14/205,292

(22) Filed: Mar. 11, 2014

Related U.S. Application Data
(60) Provisional application No. 61/776,186, filed on Mar. 11, 2013.

(51) Int. Cl. H04M 1/725; H04W 4/02

(52) U.S. Cl. CPC H04M 1/72566; H04W 4/02; H04M 1/72572
USPC 455/418

(57) ABSTRACT

Embodiments described herein provide a method and system for controlling an operation of a mobile device. The method can include selecting one or more modes of the mobile device, based on one or more predefined mode restrictions, respectively. The method can further include defining one or more selectable functions performable by the mobile device while in a respective mode, such that the mobile device is automatically configured to perform the one or more functions when the mode is activated, based on the one or more predefined mode restrictions. Methods and systems described herein allow a user to easily activate and deactivate various combinations of communication functions for various predefined modes, for a predetermined time period or at a predetermined location, for example. Moreover, a supervisor or parent can actively monitor and control the modes of subordinate or subject mobile devices remotely, as necessary.

### CLAIM OF PRIORITY

This Non-provisional application claims the benefit of the previously filed Provisional Application No. 61/776,186 entitled “Methods and Systems for Mode Scheduling in Mobile Devices,” filed Mar. 11, 2013, the contents of which are incorporated herein by reference in their entirety.

### FIELD

The present disclosure relates to wireless devices, and more particularly to methods and systems for mode scheduling in mobile devices based on time and/or location.

### BACKGROUND

As one goes about various activities of the day (e.g. sleeping, driving, working, spending time with family) is it often desirable to filter out certain communications performed by one's mobile device(s). For example, while driving, one may want to be able to make and accept calls (legally with a headset, based on certain jurisdictions), but not receive texts or social media updates. As another example, during meetings at work one may not want to receive various forms of communication from certain contacts, but always allow calls from family in case of emergency.

In conventional systems, a user is merely capable of manually turning on and off various functions, such as manually turning off cellular service, but is not able to easily activate and deactivate various combinations of functions for a predetermined time period or at a predetermined location.

### SUMMARY

The presently disclosed embodiments are directed to solving one or more of the problems presented in the prior art, as well as providing additional features that will become readily apparent by reference to the following description when taken in conjunction with the accompanying drawing.

Embodiments described herein provide a method of controlling an operation of a mobile device. The method can include selecting one or more modes of the mobile device, based on one or more predefined mode restrictions, respectively. The method can further include defining one or more selectable functions performable by the mobile device while in a respective mode, such that the mobile device is automatically configured to perform the one or more functions when the mode is activated, based on the one or more predefined mode restrictions.

Yet another embodiment described herein provides a non-transitory computer-readable medium for, when executed by a processor, performing a method of controlling an operation of a mobile device. The method can include selecting one or more modes of the mobile device, based on one or more predefined mode restrictions, respectively. The method can further include defining one or more selectable functions performable by the mobile device while in a respective mode, such that the mobile device is automatically configured to perform the one or more functions when the mode is activated, based on the one or more predefined mode restrictions.

Methods and systems described herein allow a user to easily activate and deactivate various combinations of communication functions for various predefined modes, for a predetermined time period or at a predetermined location, for example. Moreover, a supervisor or parent can actively monitor and control the modes of subordinate or subject mobile devices remotely, as necessary.

Additionally, embodiments described herein are configured to inform others about the mode a particular user has activated, so they can make a decision on whether and how to contact the particular user, based on various communication functions.

Further features and advantages of the present disclosure, as well as the structure and operation of various embodiments of the present disclosure, are described in further detail below.

### BRIEF DESCRIPTION OF THE DRAWINGS

The present disclosure, in accordance with one or more various embodiments, is described in details with reference to the following figures. The drawings are provided for purposes of illustration only and merely depict one exemplary embodiment of the disclosure. These drawings are provided to facilitate the reader's understanding of the disclosure and should not be considered limiting the breadth, scope, or applicability of the disclosure. It should be noted that for clarity and ease of illustration these drawings are not necessarily made to scale.

FIG. 1 illustrates an exemplary operating environment including wireless mobile devices, according to various embodiments of the present disclosure.

FIG. 2 illustrates an exemplary communication system including a mobile device and a base station, according to various embodiments of the present disclosure.

FIGS. 3(a) and 3(b) are an illustration of an exemplary mobile device depicting activation and deactivation of various functions in different modes at various time periods, according to various embodiments of the disclosure.

FIGS. 4(a)-4(f) show various screenshots of an interface on a mobile device, according to various embodiments of the disclosure.

FIG. 5 is a flowchart illustrating exemplary functions performed by hardware described herein, according to an embodiment.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Moreover, it should be understood that the specific order or hierarchy of functional steps in the processes disclosed herein is an example of exemplary approaches. Based upon design preferences, it is understood that the specific order or hierarchy of steps in the processes may be rearranged while remaining within the scope of the present disclosure.

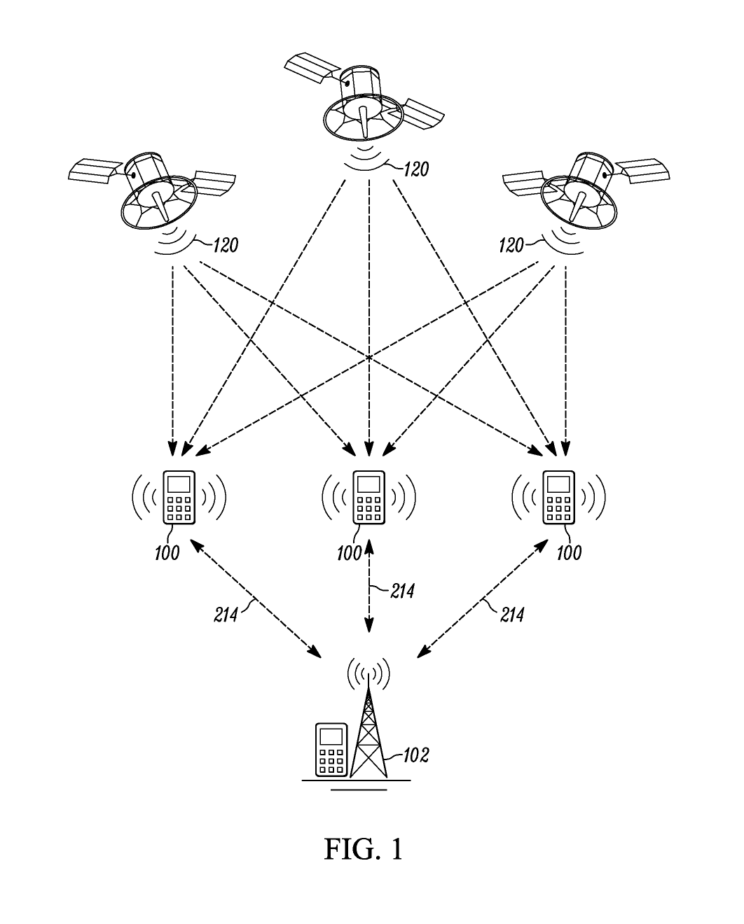

FIG. 1 illustrates a mobile radio channel operating environment, according to one embodiment of the present invention. The mobile radio channel operating environment may include a base station (BS) 102, one or more mobile stations (also referred to as MS, mobile device, or the like) 100, and global positioning system (GPS) satellites 120. As described in further detail below, the respective locations of the mobile devices 100 can be determined based on GPS satellites 120 or other known mechanisms and systems for detecting relative proximities of mobile devices 100, performed by hardware and software within mobile devices 100 themselves.

The exemplary mobile station 100 in FIG. 1 is a mobile phone; however, alternately, mobile station 100 may be a personal wireless computer such as a wireless notebook computer, a wireless palmtop computer, tablet, or other mobile computer devices.

The base station 102 can be a centralized server unit having a memory module, processor module and transceiver module, configured to store and distribute media to mobile stations 100. Accordingly to an embodiment, base station 102 can be another mobile device 100, as would be understood by one of ordinary skill in the art. Mobile stations 100 can include any conventional GPS receiver modules, which are not depicted.

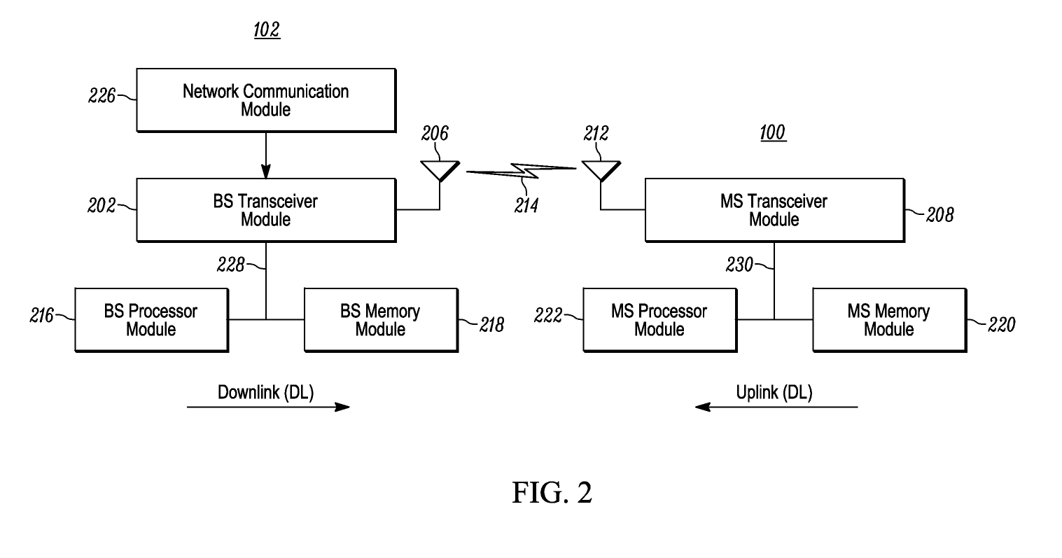

FIG. 2 shows an exemplary wireless communication system for transmitting and receiving data between mobile station 100 and base station 102, in accordance with one embodiment of the present invention. The mechanism may include components and elements configured to support known or conventional operating features that need not be described in detail herein. This system generally comprises a base station 102 with a base station transceiver module 202, a base station antenna 206, a base station processor module 216 and a base station memory module 218. System 200 generally comprises a mobile station 100 with a mobile station transceiver module 208, a mobile station antenna 212, a mobile station memory module 220, a mobile station processor module 222, and a network communication module 226. Of course both BS 102 and MS 100 may include additional or alternative modules without departing from the scope of the present disclosure.

Furthermore, these and other elements of the system may be interconnected together using a data communication bus (e.g., 228, 230), or any suitable interconnection arrangement. Such interconnection facilitates communication between the various elements of the wireless system. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

In the exemplary system, the base station transceiver 202 and the mobile station transceiver 208 each comprise a transmitter module and a receiver module (not shown). Additionally, although not shown in this figure, those skilled in the art will recognize that a transmitter may transmit to more than one receiver, and that multiple transmitters may transmit to the same receiver.

The mobile station transceiver 208 and the base station transceiver 202 are configured to communicate via a wireless data communication link 214. The mobile station transceiver 208 and the base station transceiver 202 cooperate with a suitably configured RF antenna arrangement 206/212 that can support a particular wireless communication protocol and modulation scheme. In the exemplary embodiment, the mobile station transceiver 208 and the base station transceiver 202 can be configured to support industry standards such as the Third or Fourth Generation Partnership Project Long Term Evolution (3GPP or 4GPP LTE), Time Division-Synchronous Code Division Multiple Access (TD-SCDMA), Wi-Fi, and the like. The mobile station transceiver 208 and the base station transceiver 202 may be configured to support alternate, or additional, wireless data communication protocols, including future variations of IEEE 802.16, such as 802.16e, 802.16m, and so on.

Processor modules 216/222 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. In practical embodiments the processing logic may be resident in the base station and/or may be part of a network architecture that communicates with the base station transceiver 202.

The steps of a method or algorithm described in connection with the embodiments disclosed herein may be embodied directly in hardware, in firmware, in a software module executed by processor modules 216/222, or in any practical combination thereof. A software module may reside in memory modules 218/220, which may be realized as RAM memory, flash memory, ROM memory, EPROM memory, EEPROM memory, registers, a hard disk, a removable disk, a CD-ROM, or any other form of storage medium known in the art. In this regard, memory modules 218/220 may be coupled to the processor modules 218/222 respectively such that the processors modules 216/220 can read information from, and write information to, memory modules 618/620. As an example, processor module 216, and memory modules 218, processor module 222, and memory module 220 may reside in their respective ASICs. The memory modules 218/220 may also be integrated into the processor modules 216/220. In an embodiment, the memory module 218/220 may include a cache memory for storing temporary variables or other intermediate information during execution of instructions to be executed by processor modules 216/222. Memory modules 218/220 may also include non-volatile memory for storing instructions to be executed by the processor modules 216/220.

Memory modules 218/220 may include a frame structure database (not shown) in accordance with an exemplary embodiment of the invention. Frame structure parameter databases may be configured to store, maintain, and provide data as needed to support the functionality of system 200 in the manner described below. Moreover, a frame structure database may be a local database coupled to the processors 216/222, or may be a remote database, for example, a central network database, and the like. A frame structure database may be configured to maintain, without limitation, frame structure parameters as explained below. In this manner, a frame structure database may include a lookup table for purposes of storing frame structure parameters.

The network communication module 226 generally represents the hardware, software, firmware, processing logic, and/or other components of the system that enable bi-directional communication between base station transceiver 202, and network components to which the base station transceiver 202 is connected. For example, network communication module 226 may be configured to support internet or Wi-Fi traffic. In a typical deployment, without limitation, network communication module 226 provides an 802.3 Ethernet interface such that base station transceiver 202 can communicate with a conventional Ethernet based computer network. In this manner, the network communication module 226 may include a physical interface for connection to the computer network (e.g., Mobile Switching Center (MSC)).

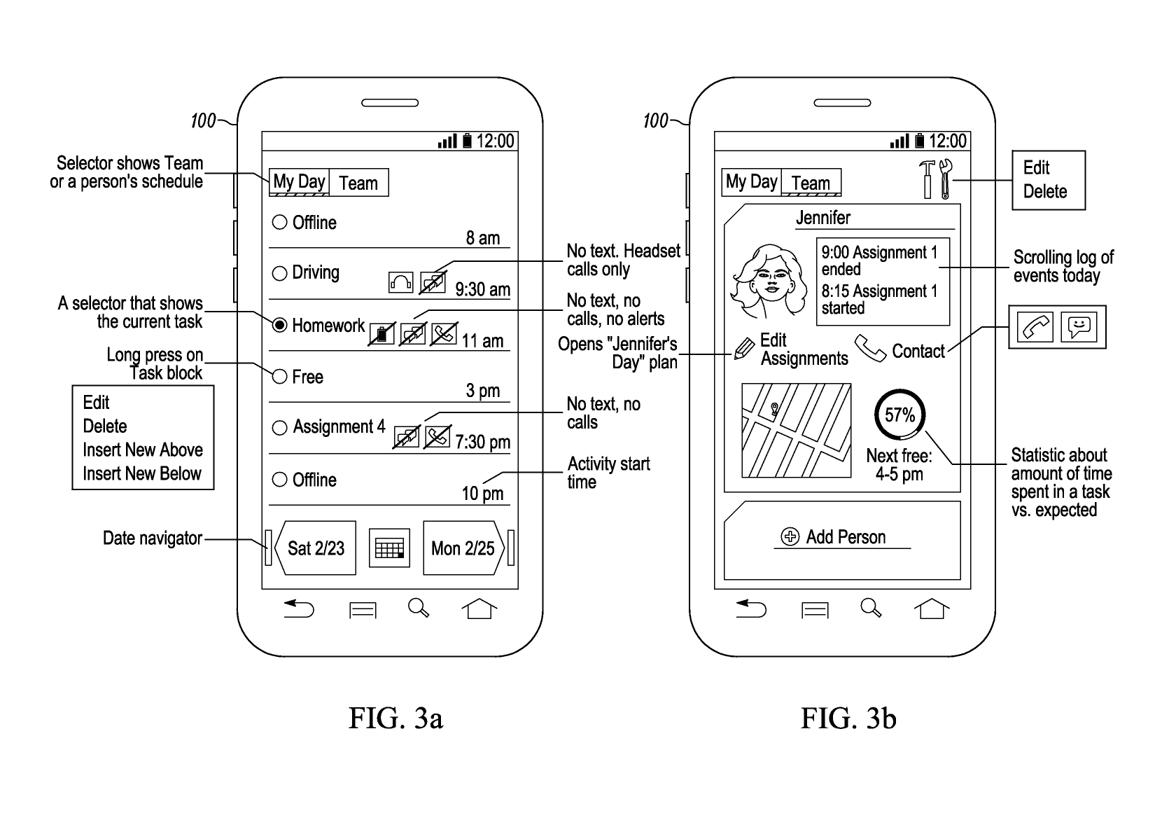

Reference will now be made to various functions performed by a mobile device (e.g., phone), for example, as shown in FIG. 3. It should be understood, however, that any device configured to transceiver voice and/or data service may be similarly employed (e.g., tablets, laptop, etc.).

As shown in FIG. 3, a user can specify a set of time block(s) and can associate a communication mode, including active and inactive communication functions, with each time block, for example. For exemplary purposes, communication functions can include, but are not limited to, voice service, text messaging, instant messaging, emailing, social media notifications, or various other applications that would be obvious to one of ordinary skill in the art, without departing from the scope of the present disclosure.

Throughout the day a person could indicate what activity they are engaged in, or are planning to be engaged in, at a particular time, and the device according to the present disclosure can enforce the communication mode restriction(s). For example, if a user is driving and the user specifies that during this activity he or she does not want to receive texts, all incoming text messages can be queued and delivered only when the user is no longer driving. Similarly, when a user is in a meeting, the device can be preset to divert phone calls from certain contacts directly to voicemail automatically, without even ringing. Furthermore, according to an embodiment, the time block calendar with the associated communication restrictions (in all or in part) can be published (e.g., via email, text message, web page, web service, etc.) to a designated group (e.g. certain friends or all contacts, etc.).

The predefined mode restrictions may be set by the user directly on the mobile device, or remotely (e.g., by another person) via another device, which can be another mobile device or any other computing device that can communicate with the mobile device via the internet or wireless communication mechanisms. According to an embodiment, one person can be allowed to control someone else's communication modes (e.g. parent controlling a child's mobile device modes). For example, the modes may be selected for a mobile device by accessing and editing a user's modes (described in more detail below), which in turn transmits the scheduling and restrictions to the mobile device via the internet or cellular service, or any other method of communicating data.

To describe an exemplary embodiment, consider a child with a smartphone where she and the parent agreed on the following time blocks for Monday: Sleep, School, Practice, Homework, Free time. In this case, all communications with friends can be restricted until Free Time (i.e., a predetermined period of time where no activity is scheduled). Namely, she will be able to access the internet during Homework; however, she will not be able to log into a social networking application or website, receive SMS text messages, or calls from friends, or their social networking updates, as an example.

According to one embodiment, the parent can switch the child over to the ‘Homework’ mode after school until the homework is done (i.e., a predetermined amount of time). The parent can do this remotely from a computer or his own smartphone, for example, which is described below.

Accordingly, the user can bind the notion of an activity (something they would engage in anyway, such as driving) with a communication mode. Switching into doing an activity automatically activates or deactivates certain predetermined communication functions. As shown in FIG. 3(a), for example, the user can simply select “Driving,” which deactivates text messaging and instant messaging. In this example, only headset (hands free) calls can be completed, as shown in FIG. 3(a). Similarly, the user can select “Homework” which deactivates other forms of communications, such as text messages, calls and social media alerts, as shown in FIG. 3.

FIG. 3(b) shows an example of sharing the activity information (e.g. time, date, etc.) for the purpose of announcing the communication restrictions with others. In this example, one can view a group (e.g., “Team”) member's (i.e., “Jennifer”) schedule, to determine when the member will be available to contact. This information can also include GPS locations, and can allow a user to edit Jennifer's assignments or contact her directly. Accordingly, a parent, for example, has the ability to control and supervise a child's communication modes, and functions performable therein.

Further, a supervised person (e.g. a child) can be enabled to control her own modes under default circumstances (e.g., “Homework”), and these changes in modes can be easily communicated to remote parents to enable them to observe these changes and intervene if necessary.

One embodiment is designed to encourage and discourage certain behaviors in persons by modifying their environment through electronic means. For example, a parent desiring to encourage a teenager to do homework for a period of time and discourage her from using social networks during that time can teach her to temporarily restrict her own access to social networks while supervising the behavior. The methods and systems described herein enable a parent, for example, to teach time-blocking, a time management technique, where a child does activities in blocks that she herself can start and stop. The classic parental controls where the parent sets up time schedules, restricts activities and web sites, is often too labor intensive for the parents and too restricting to children. Embodiments described herein allow the child to learn to be in control of her schedule, with “as needed” oversight (as described below), to achieve a more sustainable learning result.

Embodiments described herein include software stored on computer readable media and installed on one or more mobile devices available to children (computers, smartphones, tablets, etc.) that can limit or enable device capabilities. One simple configuration includes two statuses: a ‘do not disturb’ status (DnD) and an ‘available’ status. In the DnD status the child will not be disturbed by social notifications, calls, messages, lights or sounds from her device(s) and thereby her distractions will be reduces, enabling her to focus on the work instead of leisure.

According to embodiments described herein, the child learns to control her own schedule and deal with exceptions that arise in daily life. For example, she may come from school later or earlier, or they have more homework or less. This would lead to earlier or later start time and/or duration, which could be easily implemented, based on the present embodiment.

Based on the foregoing embodiments, the following features may be provided: flex-time-blocking: a child can start/stop their DnD mode themselves, which teaches kids to schedule their own time; notifying parents when kids switch modes and tracks their time in the DnD mode; if the child is outside of the expectation, parent can switch them remotely. According to one embodiment, the mode switch can become effective within X minutes (e.g., a “heads up” time that gives the child the time to finish up but the DnD time will start, whether they like it or not).

According to certain implementation options, a minimum block size and minimum target block size can include a 30 min minimum block to be productive, and/or a minimum of 1 hour/day target study time, for example.

According to certain embodiments, a one-tap mode switch can be implemented. This enables a parent to move the child in and out of the DnD mode for any reason with a tap of their smartphone. This is an “ease of use” capability that removes the burden of configuring parental control systems through multiple steps. It increases the probability that the parents will keep using the method to teach their children.

Once a device (e.g. a tablet) has been added to the parent's account (after the parent logs in with username/password the first time), for example, the device can be logged-into with short PINs (e.g. 4 digit) or swipes (swipe sequence) by everyone—kids, parents, etc. So. one can walk up to the device and types in their PIN. There is no need to have username/passwords every time, but there may be a need to distinguish users for mode-control purposes, according to this exemplary embodiment. The parent could create the PINs and the system can make sure they are not identical so a PIN is enough to identify the user and secure the process.

Another embodiment includes the ability to share one's time blocks: or “communication mode broadcast.” This provides the ability to share your activity schedule and associated communications modes with a set of friends. This way the friends know not to text you if you are in a DnD situation. The broadcast can be implemented in an number of ways, for example: 1) sending a message directly to each party interested in receiving one's availability updates; 2) posting to a cloud service that will distribute the message; and/or 3) posting on a web service or a web page and have the recipient's devices connect and retrieve it, automatically periodically or on demand.

DnD mode limitations can include, but are not limited to:

1. inability to place and/or receive calls or send and/or receive electronic messages (except to specifically allowed to contacts or destinations, i.e. a white list that may contain parents, siblings), or to specific contacts (a black-list);

2. inability to receive notifications of calls, SMS texts, social media updates (e.g. as pop-ups, LEDs, sounds);

3. inability to use certain installed applications—e.g. social network apps, games, settings;

4. allowed to use only certain white listed applications; and/or

5. have common apps, such as web browser, restricted from going to certain sites or categories of sites, or making internet connections to certain URLs or categories.

One potential mode scenario could include adding access to an exam URL, or study material not previously allowed (e.g., an “exam” mode in a school, that inhibits use of internet and calculator apps but opens access to the exam website.

Intuitively, in the DnD status the teenager is partially off the grid, where they will not be distracted by friends, but still reachable by parents, according to one possible embodiment.

Optionally, the system can further:

1. allow a parent (or a supervisor) to define separate modes and limitation/enhancement settings for a plurality of individual users (children) (e.g. for a 9-year old and for a 12-year old);

2. allow a parent and/or the user to switch modes independently of others; and/or

3. allow a parent to issue instruction to switch multiple users into a mode.

For convenience we will call the parent role a ‘supervisor’ and child a ‘subject’ in the below exemplary scenario:

In an embodiment of the disclosure the ability to switch into and out of at least one DnD mode can be made available directly to the subject. Some subjects can use it to manage their own time and avoid being distracted. Supervisors may or may not review the subjects' performance. A supervisor and a subject can be the same person, without departing from the scope of the present disclosure.

One embodiment is directed to a method including: entering into a DnD mode, such that the supervisor software: sends an electronic message to a distribution point (a server or service) or directly to the set of devices, announcing the mode switch. The server can transmit the message to the devices at a later time (and attempt to retransmit to make an effort to deliver the message) to the devices (e.g. if they are out of the wireless network range at the time of the mode switch transition); the supervisor software records the mode switch in a database, with possibly a timestamp and other metadata for convenient accounting; where the subject-configured software on the device(s): receives a message indicating that the DnD mode is on; creates a message, announcing the immediate or impending mode switch and gives an X minute/second heads up, to let the user end their activities; and enables the limitations/enhancements. Of course, not all of the steps are necessary for all embodiments, and various combinations may be included.

It should be noted that the mode switch can be per subject or per group/category of subjects (e.g. per child, per school class, etc.). The mode switch, according to this embodiment, affects at least one or a plurality of devices where the subject software is installed. In an embodiment where the device's included software, such as operating system or firmware, enables remote modification, the said mode switch can be remotely actuated by utilizing this service without additional software installation. In some embodiments, the subjects cannot switch the control modes (e.g. young children), while in some embodiments the subjects can switch the control modes (e.g. older subjects that can be held accountable to manage their own schedule)

Moreover, there can be a plurality of supervisors and subjects. Multiple supervisors can manage a subject (e.g. both parents managing a child). A supervisor can manage any number of subjects (e.g. a parent or school administrator managing a bunch of children).

As will be apparent to those of ordinary skill in the art, other features can include, but are not limited to:

1. The supervisor role can create a plurality of subject roles (e.g., accounts);

2. The supervisor can create a plurality of subject categories (a category is defined functionally—when the mode is switched for the category, every member of it gets switched into that mode);

3. Each subject can have an ID;

4. The supervisor role can create a white-list and a black-list for each subject/category;

5. The supervisor can create a list of enabled/disabled limitations/enhancements for each subject/category (e.g. contact phone numbers allowed, sites restricted, apps enabled, etc);

6. the devices with subject software can make certain dynamic information available to the supervisor software (e.g. GPS location);

7. supervisor software can collect the GPS information from the devices (directly or via a server or service);

8. supervisor software can plot the GPS on the map with time-based paths, so the supervisor knows where and when a subject has travelled;

9. A subject can express an intent to switch modes (as an announcement or asking for permission) that can be communicated to other subjects and/or supervisors;

10. A supervisor can grant such permission and/or acknowledge receipt of such request;

11. A supervisor can monitor the history of mode changes in one or more subjects;

12. supervisor software can notify the supervising user if the history of mode changes or metadata (e.g. GPS location sequence) is outside of specified parameters.

13. supervisor can specify said specified parameters (e.g. expectation that subject will be in some GPS proximity to school at 3 pm, for example, or expectation that they will switch to a study mode at 4 pm, for example).

14. Such specified parameters can be inferred algorithmically from past behavior of a specific subject, from other subjects or from a category of subjects;

15. If a subject's device is a message receiving capable device (e.g. a smart phone—it can be in a state where it can only receive calls and messages from a white list of parties. There can be a situation, e.g. in an emergency, where a supervisor (a parent) needs to reach the subject from a non-whitelisted device. To solve this problem, the supervisor can create a pin (consisting of symbols, numbers of letters) which, when included in a message (e.g. inside SMS text) will be allowed to be passed to the subject by the subject software. This scenario may arise e.g. when a parent's phone is dead and they need to give the child a number where she can reach them;

16. A supervisor can specify a minimum time block duration for a mode, e.g. 30 minutes;

17. A supervisor can specify a time range for a mode, e.g. study between 3-5 pm;

18. A supervisor can specify a minimum target time to be in a mode on a given day of the week;

19. A mode switch can be triggered based on a time series of readings from a set of device sensors: Let there be a set of sensors S={s0, s1, . . . , sN} with associated series of readouts: V_s0_t0=[v0, v1, . . . , vA], V_s0_t1=[v0′, v1′, . . . , vA′], V_s1_t0=[ . . . ] such that t0, t1, . . . tK correspond to points in time. The mode switch occurs when the overserved series matches a pre-configured pattern or satisfies a distance metric to a known vector space. For example, the series can represent the act of arriving to a destination (a series of GPS readouts—i.e. a path) and a change in a WIFI connectivity (a wireless strength readout). Another example: automatically activating the “driving” mode when the GPS and/or accelerometer observation series indicate a locomotion speed faster than walking, for example, or another predetermined velocity.

20. A mode switch can be triggered based on the location of the subject, as compared to predetermined addresses or locations. For example, when the GPS one the subject's device determines that the subject is at her school, certain modes (e.g., receiving calls and or text messaging) may be automatically deactivated until the GPS determines that the subject is no longer located at the school, or until a predetermined time (e.g., after school hours).

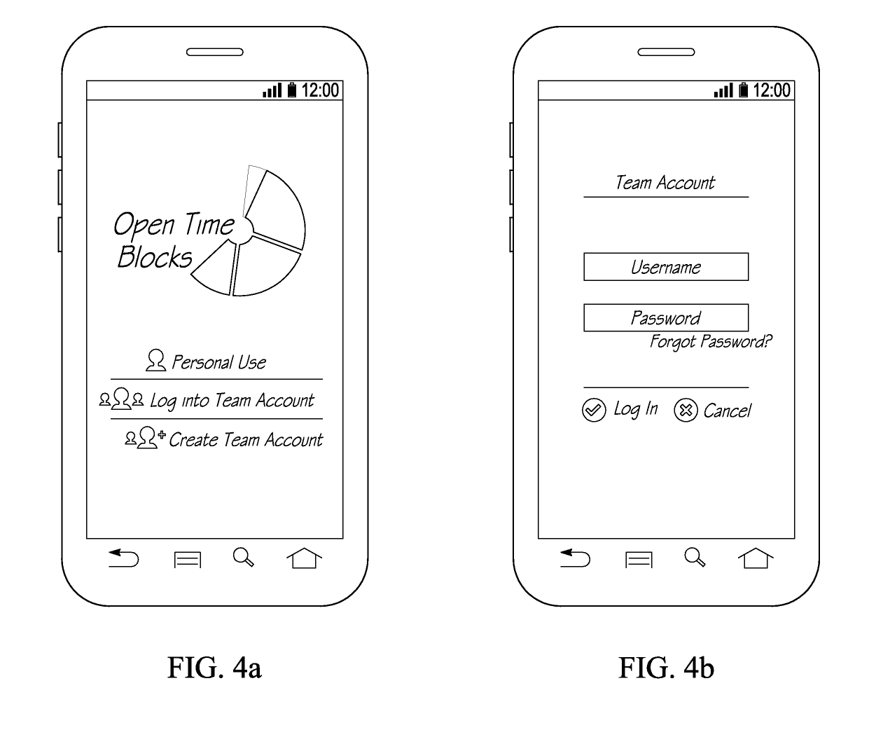

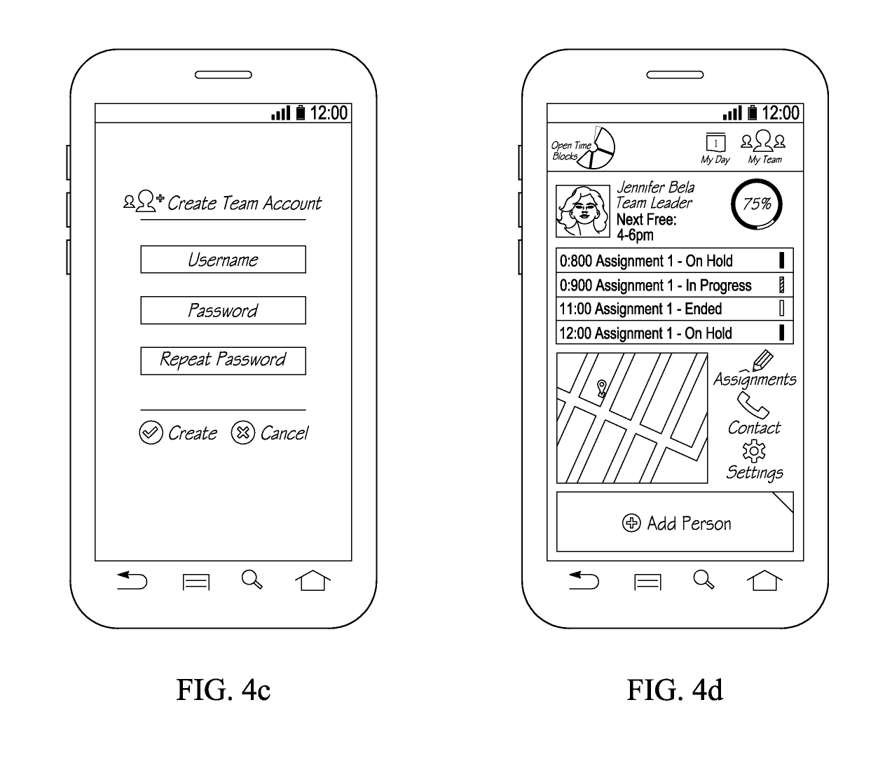

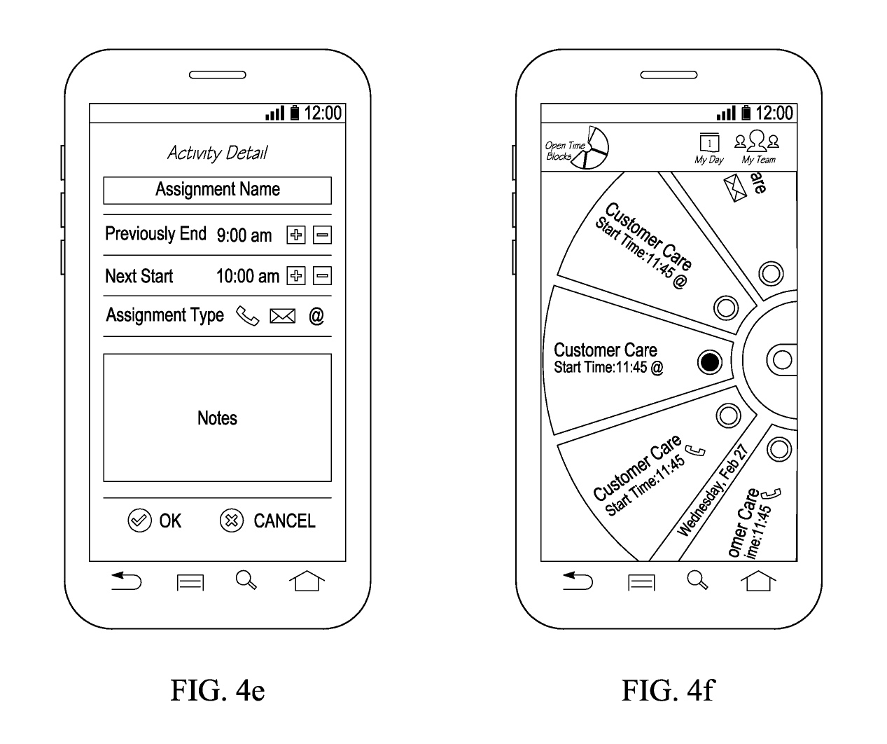

FIGS. 4(a)-4(f) show various screenshots of one exemplary interface provided to a user on a mobile device. According to this embodiment, the user can view their activities as a series of blocks (in this case a curved list that pretends to be an infinite circular calendar). Various colors or designs could indicate a type of block—here three types are defined: one color (e.g., red) means most restrictive (e.g., “do not contact me unless it's an emergency”); another color (e.g., yellow) could mean some communications allowed and others not (e.g. driving); yet another color (e.g., blue) could mean “free,” and open to all means of communication. Each block has a reference start time (e.g., for sharing purposes, so others can tell what state the user is in or will be in). Of course, the color combinations can mean various other types of blocks, or various other indicators may be used within the scope of the disclosure.

Note that according to this embodiment, as opposed to conventional calendars, there are no unallocated blocks—all parts of the day have some kind mode. Further, the user can slide her finger up and down to turn the wheel and show more time blocks she has created and can view other days as well.

In this example, the time blocks have holes at the shorter ends and one of them has a depicted ball, in one exemplary interface (see FIG. 4(f)). The user could move the ball from activity to activity as they engage in them. This ball is a trigger that switches the activities and the corresponding modes, in this example. This is merely one exemplary embodiment, and other similar mechanisms may be employed with the scope of the disclosure.

As opposed to a conventional calendar, where the passage of time would trigger the transition, here the user can trigger it herself because some activities can take less or more time, which gives this type of time block scheduling increased flexibility.

If the user presses and holds a time block slice, they can get the “Activity Detail” dialog that allows her to create a block above or below the current block, according to an example. This makes it impossible to overschedule a block, as opposed to a conventional calendar.

According to one embodiment, any day starts out as at least one block “Free” which the user could modify or create more above or below. There can be bracketing “busy” blocks (e.g., for the night time). So if the user is looking at a new day she may see “busy,” “free starting at 7 am,” and “busy starting at 10 pm.” If a user wanted to add a morning commute that she wants to be “yellow” she could press and hold the free block, insert a new yellow block above it that starts at 7 am and goes until 8 am, for example. This can cause the green “free” to now start 8 am (immediately after the commute that was inserted). If a user has a meeting from 8-10 am for which she does not want to be disturbed, she can hold the yellow block and insert a red one (for meeting), and after it choosing “Next Start” to be at 10 am. This can push the green “free” to start at 10 am and the result is “Red,” “Yellow starting at 7 am,” “Red starting at 8 am,” “Green starting at 10 am”—neatly describing one's morning for herself or anyone who she is sharing with.

The “Assignment Type” in the Activity Detail can list which communication modes are allowed/restricted, white lists, black lists, etc. (See FIG. 4(e))

The “Team” screen (see FIG. 4(d)) allows parents to monitor their kids. The activity box can show activities start/end history. The 75% graphic shows how much a particular activity has been completed (e.g. how long has the child has been in the ‘homework’ mode). The map shows the path where the child has been and is now. The “Assignments” button allows the parent to view the child's time block wheel, modify it and switch the child to another mode. “Contact” allows the parent to easily call, send a text or email to the child. “Add person” creates another monitorable person view (i.e., “card”), so multiple children could be added. Then a parent can scroll up and down through their “cards.”

Of course, the various screenshots of the exemplary interface are provided to illustrate various functions described herein, and are not intended to limit the scope of the disclosure in any way. One of ordinary skill in the art would realize that various interfaces could be similarly employed.

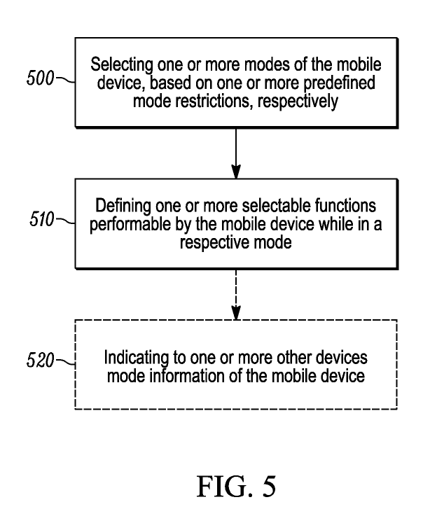

FIG. 5 is an exemplary flow diagram illustrating an exemplary method, according to an exemplary embodiment. Referring to FIG. 5, at step 500 one or more modes of the mobile device is selected, based on one or more predefined mode restrictions, respectively. As described herein, the user of the mobile device 100 can select the mode(s) him/herself, or another remote user (e.g., a parent or supervisor) can determine which modes should be selected for the user of mobile device 100, based on predetermined criteria, such as time blocks, geography and/or movement of the mobile device 100.

From step 500, the process can move to step 510 where one or more selectable functions are defined which may or may not be performed in a respective mode. Here, the user of the mobile device 100 can touch an icon, as shown in FIG. 3(a), for example. According to one example, a user can select a mode (e.g., “Driving”) and then touch an icon (or otherwise maneuver) to select or deselect functions (e.g., receiving/transmitting text messages, phone calls, music, headset-only calling, etc.) that can be performed when operating in that function. Time periods indicating when various modes automatically go into effect may also be selected and displayed, as shown in FIG. 3(a).

According to one optional embodiment, from step 510, the process can proceed to step 520, wherein mode information of mobile device 100 can be shared with another mobile device 100, as shown in FIG. 3(b). In this example, a user of the other mobile device (who may be a team supervisor or parent) can select the “Team” menu item and can bring up mode information of “Jennifer” for example, as described above. This information can include Jennifer's current mode, and when it will end, based on a predetermined time schedule. The information may also show statistics regarding an amount of time spent in a specific task (e.g., how much of a predetermined time schedule has been performed, in a specified mode), as well as when the next “free” time for Jennifer will be, where she does not have a task scheduled (e.g., there will be no mode restrictions defined by the supervisor).

GPS information of Jennifer's position may also be displayed to the supervisor, as well as a one-touch contact button, which can be used to immediately call or text message Jennifer. Moreover, an “Edit Assignments” button may be provided, which allows the supervisor to open Jennifer's schedule, in a way that Jennifer's screen as shown in FIG. 3(a) may be displayed on the supervisors device. From there, the supervisor may edit, add or remove modes and corresponding functions remotely within Jennifer's schedule.

Of course, a supervisor can have any number of team members for which the supervisor can review and edit modes and functions to be employed at desired time periods. Also, the supervisor's device is depicted as another mobile device 100 in the foregoing examples, but it should be understood that the supervisor could implement any type of mobile or other computing device (e.g., tablet, laptop, personal computer, etc.) within the scope of the disclosure. One of ordinary skill in the art would realize that the supervisor's device and the mobile device 100 can communicate via any wireless or wired communication mechanism or internet connectivity.

Based on the foregoing, a user is able to easily activate and deactivate various combinations of functions for various modes, for a predetermined time period or at a predetermined location. Moreover, a supervisor or guardian/parent can actively monitor and control the modes of subordinate or subject mobile devices remotely, as necessary.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of controlling an operation of a mobile device, comprising:
selecting one or more modes of the mobile device, based on one or more predefined mode restrictions, respectively; and
defining one or more selectable functions performable by the mobile device while in a respective mode, such that the mobile device is automatically configured to perform the one or more functions when the mode is activated, based on the one or more predefined mode restrictions.

2. The method of claim 1, wherein the one or more modes include at least one of a driving mode, homework mode, offline mode and free mode.

3. The method of claim 1, wherein the one or more predefined mode restrictions include at least one of a predefined time period, geographic location and movement of the mobile device.

4. The method of claim 1, wherein the one or more functions includes at least one of text messaging, making or receiving calls, accessing selectable applications and playing music.

5. The method of claim 1, further comprising:
indicating, to a user of a device distinct from the mobile device, a current mode in which the mobile device is operating.

6. The method of claim 1, wherein at least one of the selectable functions performable by the mobile device and the mode restrictions are selected by a second user remote from the mobile device.

7. The method of claim 6, wherein the second user can select at least one of the selectable functions performable by the mobile device and the mode restrictions remotely for one or more other mobile devices distinct from the mobile device.

8. The method of claim 3, further comprising:
determining a velocity of the mobile device; and
if the velocity is above a predetermined threshold, automatically activating a driving mode of the mobile device.

9. The method of claim 1, wherein the one or more modes includes a Do Not Disturb mode, in which the mobile device is incapable of making or receiving calls, text messages and accessing social media.

10. The method of claim 9, wherein a second user of a remote device can activate and deactivate the Do Not Disturb mode on the mobile device via a wireless connection.

11. The method of claim 1, further comprising:
indicating, to a user of a remote device, when a current mode of the mobile device is changing.

12. A non-transitory computer-readable medium storing instructions thereon for, when executed by a process, performing a method of controlling an operation of a mobile device, comprising:
selecting one or more modes of the mobile device, based on one or more predefined mode restrictions, respectively; and
defining one or more selectable functions performable by the mobile device while in a respective mode, such that the mobile device is automatically configured to perform the one or more functions when the mode is activated, based on the one or more predefined mode restrictions.

13. The computer-readable medium of claim 12, wherein the one or more modes include at least one of a driving mode, homework mode, offline mode and free mode.

14. The computer-readable medium of claim 12, wherein the one or more predefined mode restrictions include at least one of a predefined time period, geographic location and movement of the mobile device.

15. The computer-readable medium of claim 12, wherein the one or more functions includes at least one of text messaging, making or receiving calls, accessing selectable applications and playing music.

16. The computer-readable medium of claim 12, the method further comprising:
indicating, to a user of a device distinct from the mobile device, a current mode in which the mobile device is operating.

17. The computer-readable medium of claim 12, wherein at least one of the selectable functions performable by the mobile device and the mode restrictions are selected by a second user remote from the mobile device.

18. The computer-readable medium of claim 17, wherein the second user can select at least one of the selectable functions performable by the mobile device and the mode restrictions remotely for one or more other mobile devices distinct from the mobile device.

19. The computer-readable medium of claim 14, the method further comprising:
determining a velocity of the mobile device; and
if the velocity is above a predetermined threshold, automatically activating a driving mode of the mobile device.

20. The computer-readable medium of claim 12, wherein the one or more modes includes a Do Not Disturb mode, in which the mobile device is incapable of making or receiving calls, text messages and accessing social media.

21. The computer-readable medium of claim 20, wherein a second user of a remote device can activate and deactivate the Do Not Disturb mode on the mobile device via a wireless connection.

22. The computer-readable medium of claim 12, the method further comprising:
indicating, to a user of a remote device, when a current mode of the mobile device is changing.
